(19) United States
(12) Patent Application Publication
(10) Pub. No.: US 2013/0275862 A1
(43) Pub. Date: Oct. 17, 2013

(54) System and Method for Providing a Product-Based Chat Session

(71) Applicant: Hosni I. Adra, Naperville, IL (US)

(72) Inventor: Hosni I. Adra, Naperville, IL (US)

(21) Appl. No.: 13/863,792

(22) Filed: Apr. 16, 2013

Related U.S. Application Data
(60) Provisional application No. 61/624,839, filed on Apr. 16, 2012.

(51) Int. Cl. H04L 12/58

(52) U.S. Cl. CPC H04L 51/04
USPC 715/234

(57) ABSTRACT

A computer-implemented method includes detecting that a user has accessed a website via a browser application hosted on a computing device, tracking products being searched by the user on webpages associated with the accessed website, and triggering a chat session involving a chat agent based on the products searched by the user.

### CROSS-REFERENCE TO RELATED APPLICATIONS

The present application claims priority under 35 U.S.C. §119(e) to U.S. Provisional Patent Application Ser. No. 61/624,839, filed Apr. 16, 2012, which is incorporated herein by reference in its entirety.

### BACKGROUND

Unless otherwise indicated herein, the materials described in this section are not prior art to the claims in this application and are not admitted to be prior art by inclusion in this section.

With the ever-increasing use of the Internet to sell products, online stores, services, or web presences need to be as connected as possible to their site visitors. Accordingly, online chat sessions have become an increasingly useful tool for Web site operators in communicating with users visiting their Web site. Chat sessions also help customer services associates directly engage Web site visitors early in the service experience, in order to help prevent the visitor from losing interest in the business and help prevent the business from losing the visitor.

As known to one of ordinary skill in the art, when a user accesses a particular Web site, an associated online business has the ability to determine which Web pages have been recently viewed by the visitor and initiate a chat session based on that determination. However, during a chat session conventional chat systems are not configured to provide any additional info regarding the user behavior.

Therefore, there is a need for a system and method that provide a chat agent during a chat session access to additional navigation information about the Web site visitor.

### SUMMARY

Disclosed herein are a system and method for providing a product-based chat session

In one embodiment, a computer-implemented method includes detecting that a user has accessed a website via a browser application hosted on a computing device, tracking products being viewed by the user on webpages associated with the accessed website, and triggering a chat session involving a chat agent based on the products viewed by the user.

In one aspect, the product-based chat session is configured to automatically engage the user using targeted messages.

In another aspect, the targeted messages are based on the products viewed, product categories, and historical analysis of similar users search pattern and products that have been purchased.

In another aspect, the method includes analyzing the product search performed by the used based on geographical patterns, user behavior, and demographics.

In another embodiment, a non-transitory computer readable storage medium contains instructions that cause a computing system to perform the method for providing a chat session based on products searched by a user.

These as well as other aspects, advantages, and alternatives will become apparent to those of ordinary skill in the art by reading the following detailed description, with reference where appropriate to the accompanying drawings. Further, it should be understood that the disclosure provided in this summary section and elsewhere in this document is intended to discuss the invention by way of example only and not by way of limitation.

### BRIEF DESCRIPTION OF THE DRAWINGS

FIG. 1 illustrates a plurality of embodiments of client computing devices in communication with a server computer via a network;

FIG. 2A is a schematic diagram view of one embodiment of a computing system associated with the computer server of FIG. 1;

FIG. 2B is a schematic diagram view of one embodiment of a computing system associated with one of the client computing devices of FIG. 1;

FIG. 3 illustrates an example embodiment of a search query communication between one of the client computing devices and the server computer of FIG. 1;

FIG. 4 is a flow chart of a method for providing a product-based chat session; and

FIG. 5 is a schematic diagram illustrating a conceptual partial view of an example computer program associated with the method of FIG. 4.

### DETAILED DESCRIPTION

In the following detailed description, reference is made to the accompanying figures, which form a part thereof. In the figures, similar symbols typically identify similar components, unless context dictates otherwise. The illustrative embodiments described in the detailed description and figures are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

A computer-implemented method and system for providing a product-based chat session is disclosed. In the following description, numerous specific details are set forth. However, it is understood that various embodiments may be practiced without these specific details. In other instances, well-known processes, structures and techniques have not been shown in detail in order not to obscure the understanding of this description.

### Overview

As stated above, with the increasing use of the internet to sell products, it is imperative that each online store, service, or web presence be as connected as possible to the site visitors. As visitors access the site, and browse through products, the online seller has the ability to connect and initiate a chat. But without knowing exactly what the user is searching for, or the history of that person's searches online, it is not possible to properly engage the shopper effectively.

Accordingly, to optimize each Web site presence and effectiveness, a system and method are configured to enable a chat system that incorporates historical site searches and current browsing behavior of the Web site visitor. One advantageous feature that enhances the effectiveness of the system and method is a connectivity of a chat agent to a seller's inventory. Instead of displaying web pages and URLs the visitor is viewing or has looked at, the system displays a product list that the user has searched and viewed. In one embodiment, the user's historical navigation and current behavior are mapped to an inventory or service items that the seller is providing online. Another advantageous feature involves determining which other Web sites associated with businesses in competition with the seller have been navigated by the user.

Moreover, the system enables the seller to either automatically engage the visitor using targeted messages based on the products viewed, product categories, or historical analysis of similar users search pattern and products that have been purchased. In addition, the system is configured to enable the seller to write targeted messages based on the products being searched. As a result of the data collected, product search analysis is provided based on geographical patterns, user behavior, demographics and other factors that are of interest to the seller. The historical data is used to better target a process of engagement and messages used to pull a user into a chat session.

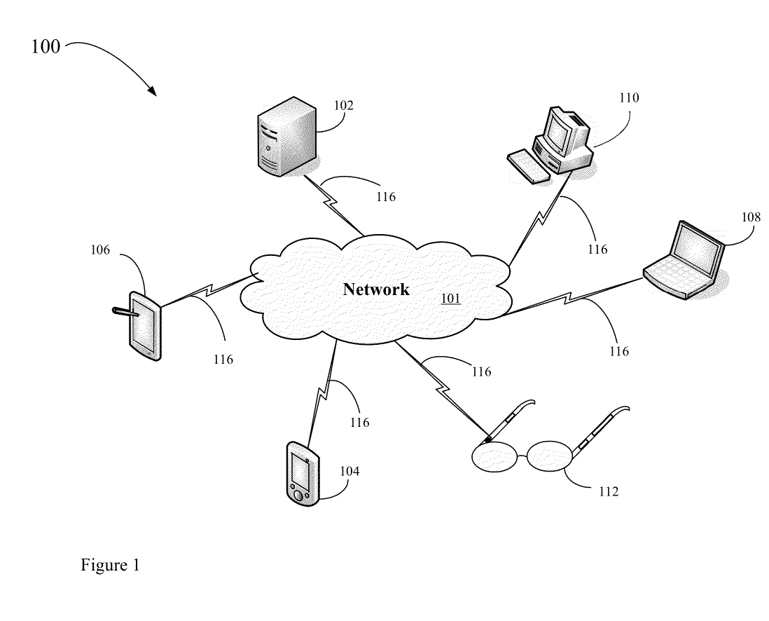

Referring to FIG. 1, a diagram illustrates an exemplary network environment in which the various embodiments can operate. As shown, a server computer system 102 is coupled to a wide-area network 101. Wide-area network 101 may include the World Wide Web (WWW), also known or referred to as the Internet, or other proprietary networks, which are well known to those of ordinary skill in the art. Wide-area network 101 may include conventional network backbones, long-haul telephone lines, Internet service providers, various levels of network routers, and other conventional devices or apparatuses for routing data between computers. Using conventional network protocols, server computer system 102 may communicate through wide-area network 101 to a plurality of client computing devices connected to wide-area network 101 in various ways. The plurality of computing devices may include a smart cellular phone 104, such as an Apple's iPhone or a Google's Android, a tablet or notebook computer 106, such as an Apple's iPad, a laptop computer 108, a desktop computer 110, a personal data assistant (PDA) (not shown), or a hybrid device that includes any of the above functions. In one embodiment, one of the client computing devices may be a head wearable computing device 112.

It should be noted that the terms “user,” and “visitor,” which are used interchangeably in many embodiments herein, mean a person or business that is a past, current, or potential customer of the seller. Moreover, these two terms may include any association, machine, apparatus, and/or any other device capable of engaging in a chat session.

For the sake of simplicity, a user is assumed to utilize laptop computer 108 to browse a website hosted by server computer system 102. Laptop computer 108 may be connected wirelessly to wide-area network 101 through a wireless link 116, or through a direct or dial-up telephone line (not shown), or other network transmission line (not shown). In an alternative network topology, wide-area network 101 may be connected to a gateway computer (not shown). Typically, gateway computers are used to route data to a client computing device through a local area network (LAN) (not shown). In this manner, the client computing device can communicate with server computer system 102 through the gateway computer and wide-area network 101.

Using one of a variety of network connections, server computing system 102 can communicate with client computing devices 104-110. In a particular implementation of this network configuration, server computer system 102 may operate as a Web server if the Internet is used for wide area network 101. Using the Hypertext Transfer Protocol (HTTP) and the Hypertext Markup Language (HTML), for example, across wide-area network 101, server computer system 102 may communicate across the Internet with client computing devices 104-110. In this configuration, client computing devices 104-110 may use a client application program known as a web browser application, such as the Internet Explorer™ published by Microsoft Corporation, a user interface of America On-Line™, or a web browser or HTML renderer of any other supplier. Using such conventional browsers and the Internet, client computing devices 104-110 may access image, graphical, and textual data provided by server computer system 102 or they may run Web application software. In one embodiment, the web browser application is enabled to employ Standard Generalized Markup Language (SMGL), HTML, eXtensible Markup Language (XML), Handheld Device Markup Language (HDML), Wireless Markup Language (WML), WMLScript, JavaScript, and the like, to display a piece of content. Moreover, client computing devices 104-110 may employ any of a variety of other web based languages.

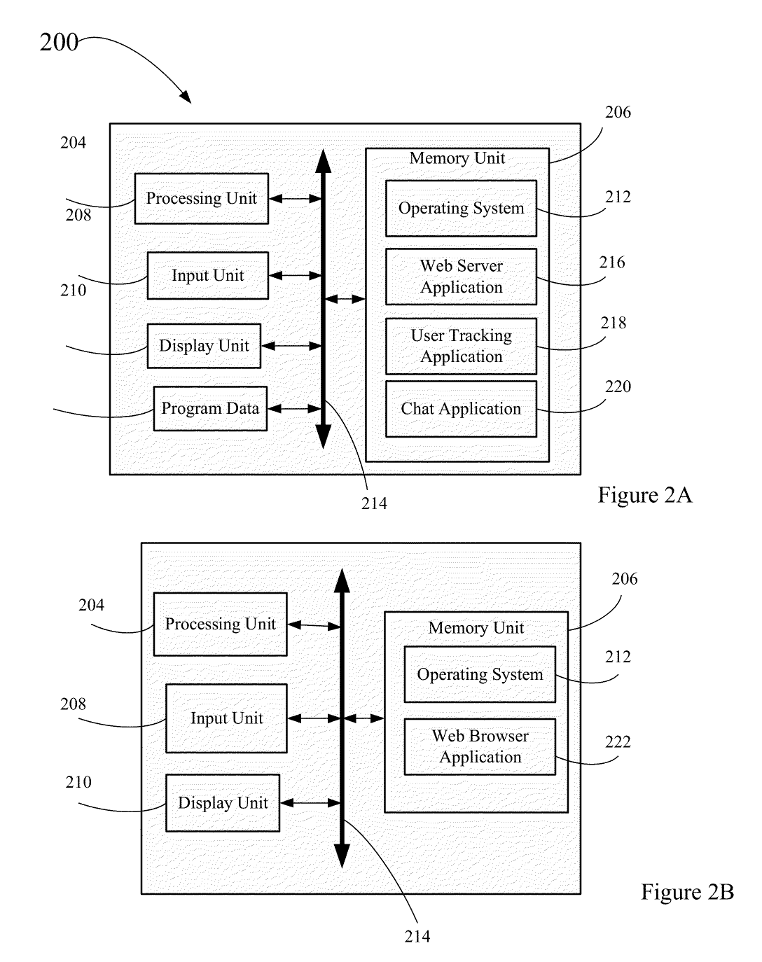

FIG. 2A illustrates an exemplary embodiment of a computing system 202, which may be integral to server computing system 102, in which features of various embodiments may be implemented. As shown, computing system 202 includes a processing/processor unit 204, a memory unit 206, an input unit 208, a display unit 210, and a database 212. Computing system 202 further includes a bus 214 for enabling transmission of information between computing system components 204-212.

FIG. 2B illustrates an exemplary embodiment of an alternate computing system, which may be integral to one of client computing devices 104-110. This alternate computing system may include similar components to those of server computing system 102, such as processing unit 204, memory 206, which includes a web browser application 222, rather than web server application 216 of server computer server system 102.

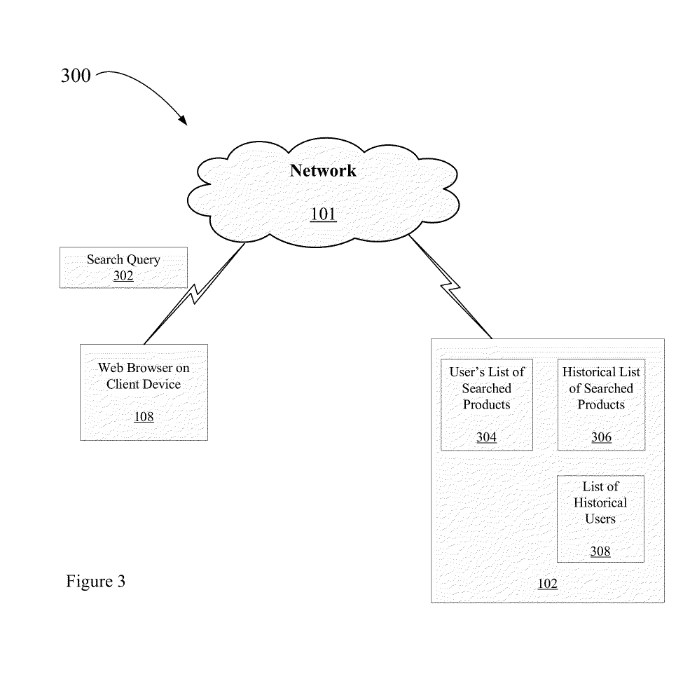

Referring to FIG. 3, in one embodiment, the user, using one of client computing devices 104-110, submits a search query 302, via a user interface provided on display unit 210, to a search engine (not shown) running on computing system 202 via wide-area network 101. Upon receiving search query 302 for a product or a service, the search engine may display on the user interface a search results page, which includes links that are associated with uniform resource locators (URLs) of companies or businesses that may manufacture and/or sell the searched product or similar products, or may provide the searched service or similar services. Hereafter, for the sake of simplicity, we assume that the search initiated online by the user is for a product, rather than for a service.

After reviewing the search results page, the user may select and click on one of the links to access a website of one of the listed businesses. In one embodiment, the link selected by the user is assumed to be associated with a business website hosted on server computing system 102.

Upon accessing the business website, the user may navigate through available webpages in order to seek and view as much information as possible regarding the searched product or any other similar products presented on those webpages. During the visitor's navigation, user tracking application 218 is configured to helps track the actions of the visitor. In one embodiment, tracking application 218 is configured to track how each visitor or consumer navigates through the website, which links he/she uses, which pages he/she visits, how much time he/she spends on each page, where did he/she comes from and the browsers he/she uses. In one embodiment, tracking application 218 is configured to determine and show the chat agent at which point he/she leave the Web site and where he/she decided to buy. Tracking application 218 may also provide information about how each website visitor found the website, i.e., whether through a search engine or a link. In one embodiment, using the above discussed information acquired about the user's historical navigation and current behavior and during the chatting, chat session application 220 information may help the chat agent establish effective marketing strategies by triggering a Web search of similar products to best price at least one of the products viewed by the visitor. Based on these established marketing strategies, chat agent may determine competitive prices and provide them live to the visitor during the chat session.

In another embodiment, tracking application 218 is configured to store the visitor's chat history, contact information and footprint in the business Web site server, which helps to identify each visitor once he/she logs in again, and chat agent can check the browsing history of visitor. As such, when a visitor accesses the business Web site more than once and browses a particular page for a particular product, tracking application 218 is configured to tag him/her as a potentially valuable customer. Moreover, when the visitor accesses the Web site using a search keyword that matches at least one product of a pre-set product list, tracking application 218 is configured to tag him as a hot prospect customer.

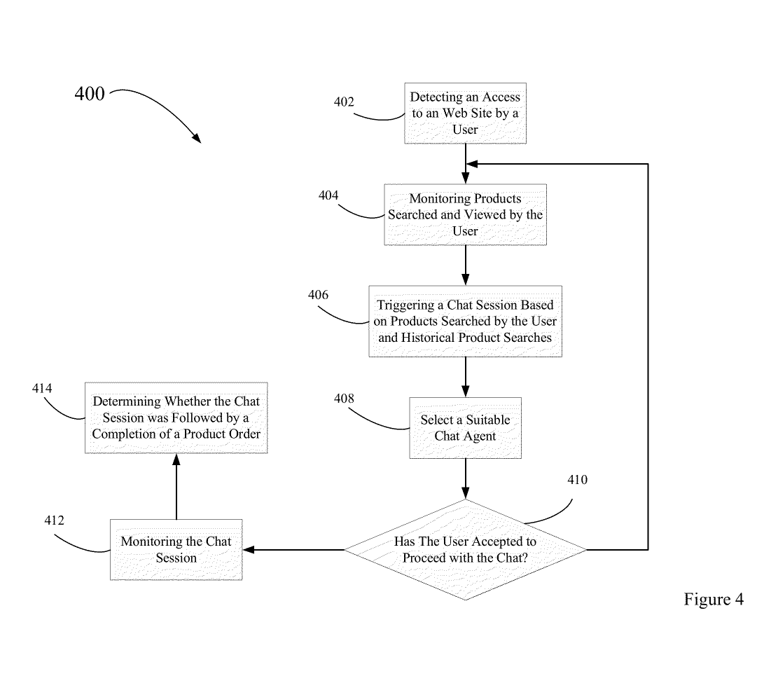

Now referring to FIG. 4, a flow chart illustrates a method for triggering a chat session with the user based his/her Web site navigation and searching/viewing of particular products. After detecting the user's access to the website, at step 402, computing system 202 is configured via user tracking application 218 to monitor the user navigation around the website, i.e., monitor the different webpages visited as well as the various products searched and viewed by the user, at step 404. In one embodiment, user tracking application 218 may also track how much time is spend on each visited webpage and on each viewed product. As such, user tracking application 218 monitors the user's progress about the website so that server computing system 102 is continuously updated as to what webpage is on and what particular product the user is viewing, and when the user has reached a certain web page and has viewed a certain product.

In one embodiment, user tracking application 218 may also be configured as a mining tool or application. As such, user tracking application 218 may determine the user's demographics, product interests, e.g., searched product list 304 shown in FIG. 3, identity, and any other suitable user aspects gathered from the tracked browsing behavior or history of the user. By collecting such user information for every visiting user, computing system 202 may able to generate a list 306 of historical product searches and a corresponding historical list 308 of historical users.

Based on a current website browsing of the user, historical product searches list 306, and a current product inventory, at step 406, computing system 202 may trigger a chat session via chat application 220 between the chat agent and the visiting user. At step 408, the chat agent is preferably selected by chat application 220 based on his/her availability and whether he/she is skilled in the subject matter related to the user's product searches. Alternatively, the chat agent may not be a live chat agent, i.e., a person, but rather an artificially intelligent chat agent, i.e., a chatbot. Once the selected chat agent is found to be available, chat application 220 may cause a chat client user interface to appear on the currently viewed webpage. That is, chat application 220 may cause the chat client user interface to be displayed as a pop-up window and may provide an initial question message, such as “Do you want to chat?” Alternatively, chat application 220 may cause the chat client user interface to appear as part of the currently displayed web page. Subsequently, the user may provide an indication that he/she wants to proceed with the chat, by replying affirmatively to the initial question or otherwise, at step 410. If the user indicates that he/she does want to chat, the indication is transmitted via the browser through wide-area network 101 to server computing system 102, and the process proceeds to the chat session.

In one embodiment, computing system 202 may monitor the navigation of the user (e.g., using tracking pixels or a tracking file) to determine if the user browser has navigated to a particular webpage and has viewed a particular product. If the user has viewed or sought additional information regarding the particular product, chat application 220 may send an alert to the chat agent assigned to the chat session. By way of example, the alert can be in the form of a text message and/or can cause an icon to be displayed on the chat agent client, and/or can cause the agent client to emit a tone or other audible signal. The text message provided to the chat agent may include the product or a list of products that the user has viewed. In addition, the alert may be send based on a comparison between the list of products viewed and the business inventory. As stated above, the alert may also include a list of comparable products discovered by crawling other Web sites. Accordingly, computing system 202 is configured to map historical product searches, the current user browsing behavior to inventory products that the business is providing on-line, and comparable Internet-located products.

In another embodiment, at step 412, during the chat session with the user, the chat agent may ask the user pertinent questions regarding the product he/she is searching, and answers questions that the user may have submitted via the chat interface, as well as push the user through the web site to show additional pertinent products, listed in online catalog pages for example, or to help the user fill out forms, with the chat client interface persistently displayed, optionally at the same physical location. In this manner, the chat agent may drive the user around the business's web site and guide him/her to pertinent products for which the user is looking or which the chat agent wants him/her to view and consider purchasing. In one embodiment, at least of the pertinent products may have their prices changed to render them more competitive relative to the products discovered on the Internet by the chat agent during the chat session. Moreover, the chat agent may direct the user to a webpage where he/she can place an order for a product or service. At step 414, computing system 202 is further configured to track whether the user has completed his/her order and received a confirmation page stating that the order was successfully submitted.

In one embodiment, computing system 202 is configured to determine via chat application 220 when the chat session has ended, and whether it ended by the user or the chat agent by closing the chat interface, activating an “end chat” control, or otherwise. If the chat session has ended, chat application 220 may remove the chat user interface from the webpage being viewed by the user, and optionally, the other web page content may be repositioned so that some of the web page content occupies at least a portion of the area previously occupied by the chat user interface.

Accordingly, the above-described system and method are configured to provide a chat process that incorporate historical site searches, current user product browsing behavior, Internet searches for comparable products performed during the chat session. Historical product searches and purchases and current behavior are mapped to inventory or individual service items that the seller is providing online As a result of the monitoring of the users, product search analysis is generated based on geographical patterns, user behavior, demographics and other factors that may be of interest to the business.

Referring back to FIG. 2A, processor unit 204 is configured to execute instructions and to carry out operations associated with computing system 202. For example, using instructions retrieved from memory unit 206, processor unit 204 may control the reception and manipulation of input and output data between components of computing system 202. Processor unit 204 can be implemented on a single-chip, multiple chips, or multiple electrical components. For example, various architectures can be used for processor unit 204, including dedicated or embedded processor, single purpose processor, controller, application-specific integrated circuit (ASIC), and so forth. In most cases, processor unit 204 together with an operating system operates to execute computer code, and produce and use data.

Memory unit 206 generally provides a place to store computer code and data that are used by computing system 202. Memory unit 206 may include read-only memory (ROM), random-access memory (RAM), a hard disk drive and/or the like. In addition to an operating system 212, memory unit 206 further includes a Web server application 216, a user tracking application 218, and a chat application 220. As stated above, user tracking application 218 is configured track the actions or activities of the user while visiting a business website.

Display unit 210, operatively coupled to processor unit 204 may be a liquid crystal display (LCD) (e.g., active matrix, passive matrix and the like), a light-emitting diode (LED) display, a plasma display, a display implemented with electronic inks, or any other suitable or desirable display. Additionally, display unit 210 may include input characteristics of input unit 208, by displaying a GUI (not shown) that can provide an easy to use interface between a user of computing system 202 and an operating system or an application running thereon. In one embodiment, display unit 210 may include a touch screen, such as the ones typically associated with smart cellular phones, tablets, or notebook computers.

Accordingly, a computing system includes software, information processing hardware, and various processing steps, which will be described below. The features and process steps of the various embodiments may be implemented in machine or computer executable instructions. The instructions can be used to cause a general purpose or special purpose processor, which is programmed with the instructions to perform the steps of the various embodiments. Alternatively, the features or steps of the various embodiments may be performed by specific hardware components that contain hard-wired logic for performing the steps, or by any combination of programmed computer components and custom hardware components. While various embodiments will be described with reference to the Internet, the systems and methods described herein are equally applicable to other network infrastructures or other data communications systems.

Various embodiments include a computer-implemented method for providing a product-based chat session, and will be described hereafter. The use of the various embodiments with various types and formats of user interface presentations will not be described, but will be apparent or obvious to one of ordinary skill in the art. In the description that follows, various embodiments are described as implemented in computer-implemented processing logic denoted herein as the “Software.” However, their implementation may not be limited to a purely computer-implemented processing.

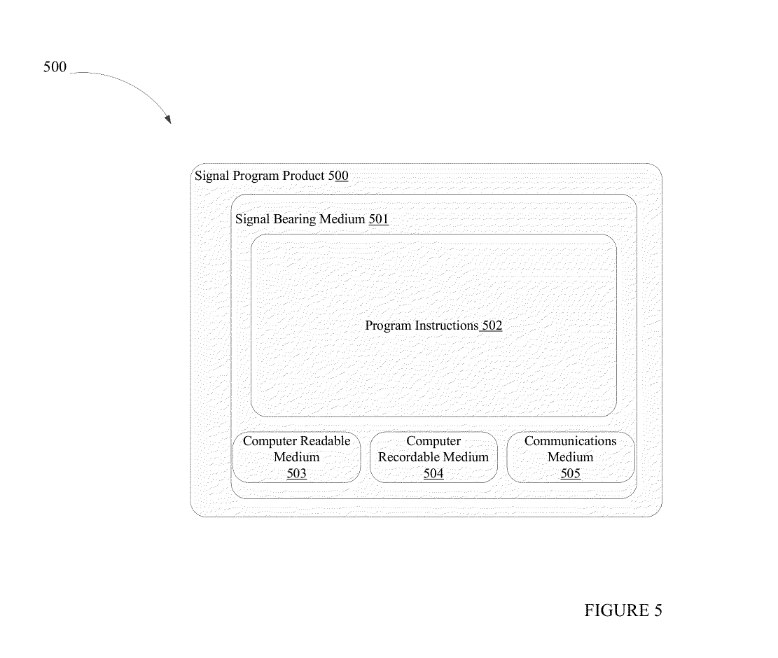

In some embodiments, the above-discussed method may be implemented as computer program instructions encoded on a computer-readable storage media in a machine-readable format. FIG. 5 is a schematic illustrating a conceptual partial view of an example computer program product 500 that includes a computer program for executing a computer process on a computing device, arranged according to at least some embodiments presented herein. In one embodiment, the example computer program product 500 is provided using a signal bearing medium 501. The signal bearing medium 501 may include one or more programming instructions 502 that, when executed by one or more processors may provide functionality or portions of the functionality described above with respect to FIGS. 1-4. Thus, for example, referring to the embodiment shown in FIG. 4, one or more features of blocks 402, 404, 406, 408, 410, 412, and/or 414 may be undertaken by one or more instructions associated with the signal bearing medium 501.

In some examples, the signal bearing medium 501 may encompass a non-transitory computer-readable medium 503, such as, but not limited to, a hard disk drive, a Compact Disc (CD), a Digital Video Disk (DVD), a digital tape, memory, etc. In some implementations, the signal bearing medium 501 may encompass a computer recordable medium 504, such as, but not limited to, memory, read/write (R/W) CDs, R/W DVDs, etc. In some implementations, the signal bearing medium 501 may encompass a communications medium 505, such as, but not limited to, a digital and/or an analog communication medium (e.g., a fiber optic cable, a waveguide, a wired communications link, a wireless communication link, etc.). Thus, for example, the signal bearing medium 501 may be conveyed by a wireless form of the communications medium 505 (e.g., a wireless communications medium conforming to the IEEE 802.11 standard or other transmission protocol).

The one or more programming instructions 502 may be, for example, computer executable and/or logic implemented instructions. In some examples, a computing device such as the computing system 202 of FIG. 2 may be configured to provide various operations, functions, or actions in response to the programming instructions 502 conveyed to the computing system 202 by one or more of the computer readable medium 503, the computer recordable medium 504, and/or the communications medium 505.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. A computer-implemented method comprising:
detecting that a user has accessed a Web site of a seller via a browser application hosted on a computing device;
tracking the user behavior on webpages associated with the accessed website to identify which products are of interest to the user, wherein the products of interest are identified based on product searches performed by the user; and
triggering a chat session involving a chat agent abased on the products of interest searched by the user.

2. The computer-implemented method of claim 1, wherein the product-based chat session is configured to automatically engage the user using targeted messages.

3. The computer-implemented method of claim 2, wherein the targeted messages are based on the products viewed, product categories, and historical analysis of similar users search pattern and products that have been purchased.

4. The computer-implemented method of claim 3, further comprising:
analyzing the product search performed by the used based on geographical patterns, user behavior, and demographics.

5. The computer-implemented method of claim 3, wherein the product search analysis is used to target a process of engagement and to generate the targeted messages to pull the user into the chat session.

6. The computer-implemented method of claim 3, further comprising;
performing during the chat session a search for comparable products by accessing other Web sites to determine competitive prices for the products of interest to the user; and
providing the determined competitive prices to the user via the chat session.

7. The computer-implemented method of claim 6, further comprising:
directing the user to a webpage where he/she can place an order for one of the products of interest.

8. The computer-implemented method of claim 7, further comprising:
determining whether the user has completed his/her order; and
providing to the user a confirmation indicating that the order was successfully submitted based on the determination that the order was completed.

9. A non-transitory computer readable storage medium having stored therein instructions executable by a computing device to cause the computing device to perform functions, the functions comprising:
detecting that a user has accessed a Web site of a seller via a browser application hosted on a computing device;
tracking the user behavior on webpages associated with the accessed website to identify which products are of interest to the user, wherein the products of interest are identified based on product searches performed by the user; and
triggering a chat session involving a chat agent abased on the products of interest searched by the user.

10. The non-transitory computer readable storage medium of claim 9, wherein the product-based chat session is configured to automatically engage the user using targeted messages.

11. The non-transitory computer readable storage medium of claim 10, wherein the targeted messages are based on the products viewed, product categories, and historical analysis of similar users search pattern and products that have been purchased.

12. The non-transitory computer readable storage medium of claim 11, further comprising:
analyzing the product search performed by the used based on geographical patterns, user behavior, and demographics.

13. The non-transitory computer readable storage medium of claim 11, wherein the product search analysis is used to target a process of engagement and to generate the targeted messages to pull the user into the chat session.

14. The non-transitory computer readable storage medium of claim 11, further comprising;
performing during the chat session a search for comparable products by accessing other Web sites to determine competitive prices for the products of interest to the user; and
providing the determined competitive prices to the user via the chat session.

15. The non-transitory computer readable storage medium of claim 14, further comprising:
directing the user to a webpage where he/she can place an order for one of the products of interest.

16. The non-transitory computer readable storage medium of claim 15, further comprising:
determining whether the user has completed his/her order; and
providing to the user a confirmation indicating that the order was successfully submitted based on the determination that the order was completed.
